(19) United States
(12) Patent Application Publication
(10) Pub. No.: US 2005/0071522 A1
(43) Pub. Date: Mar. 31, 2005

(54) Method for operating a field device

(76) Inventor: Vincent DeGroot, St Louis (FR)

Correspondence Address: BACON & THOMAS, PLLC, 625 SLATERS LANE, FOURTH FLOOR, ALEXANDRIA, VA, 22314, US

(21) Appl. No.: 10/496,506

(22) PCT Filed: Nov. 20, 2002
(86) PCT No.: PCT/EP02/12980

(30) Foreign Application Priority Data
Nov. 23, 2001 (DE) 101573235

(51) Int. Cl. G06F 3/00

(52) U.S. Cl. 710/15

(57) ABSTRACT

In a field device F1, a field device application program is executed in a microprocessor. This field device application program includes different parts, which relate to the separate functions of the field device, e.g. communication, measurement registration and evaluation, as well as a part M1A, which describes the functionality of the field device F1. This part M1A of the field device application program is obtained from an intermediate code Z by means of an interpreter J1. For operating the field device F1 from an operating device S, the intermediate code Z is transmitted into the operating device S and executed there. In this way, the full functionality of the field device F1 is available to the operating device S.

The invention relates to a method for operating a field device.

In the technology of automation, field devices are frequently used for registering and/or influencing process variables. Examples of such field devices are fill level measuring devices, mass flow meters, pressure measurers, temperature measurers, etc., which register the corresponding process variables fill level, mass flow rate, pressure and temperature. For influencing process variables, so-called actuators are used, which, e.g. as valves, influence the flow rate of a liquid in a section of pipeline.

The field devices are, as a rule, connected over a data bus with a control- or, as the case may be, an engineering-system, which controls the entire process flow, respectively enables a direct access to the individual field devices. With the direct access, settings can be changed in the field device, or special diagnosis functions can be called up. Besides access via the control system, a temporary access is also possible e.g. using a portable handheld operating device, portable computer, or a cell phone. In the control system, the measurements of the various process variables are evaluated, or monitored, as the case may be, and the appropriate actuators for influencing the process are correspondingly controlled. Data transmission between field device and control system occurs according to the known international standards for field busses, such as, e.g., Hart, Foundation Fieldbus, Profibus, CAN, etc.. In the case of current automation setups, a multiplicity of field devices from a wide variety of manufacturers is frequently used. Before startup, or during operation, as the case may be, settings must occur at the field devices. For this purpose, the separate field device manufacturers supply operating-, respectively configuring-programs. These programs are manufacturer specific and usually only permit the accessing of the field devices of the given manufacturer. Access of foreign devices is only possible in limited cases.

In order to enable the operation of different field devices from the operating device, the functionality of the field device must be known to the access device. The functionality of the field device is determined by the field device application program, which runs in the field device. The functionality of the field device has been described, to this point in time, by means of a device description. A special language, the Device Description Language, is available for this. By means of this standardized language, the required information concerning the functionality of designated field devices can be transmitted to other bus participants, especially to the control system or to another operating device.

Disadvantageous here is that the device descriptions must be written extra and independently of the field device program. This means additional programming expense. In the case of program changes, also the device description of the field device must be changed. A further disadvantage is that inconsistencies are possible between field device program and device description. The device description is not compelled to reflect the functionality of the field device exactly.

The commonly originating application EP-0913 750, with application filing date of 31 Oct. 1999, discloses an arrangement for operating a field device involving a Java bytecode running in both the field device and the operating device. Disadvantageous in this is that one is limited to a certain programming language (Java) in creating the field device program.

An object of the invention is to provide a method permitting a safe and simple operation of a field device from an operating device, without there being a limitation to a certain programming language.

The object is achieved by a method for the remote operating and/or remote control of a field device by means of an operating device over a data bus with the following method steps:

(1) Storing in the field device an intermediate code describing the functionality of the field device;

(2) converting the intermediate code with an interpreter into a field device machine code, which is part of a field device application program;

(3) transmitting the intermediate code to the operating device;

(4) converting the intermediate code with an interpreter into an operating device machine code, which is part of an operating device application program, so that the identical functionality of the field device is available in the operating device;

(5) transmitting the field device parameters to the operating device; and

(6) executing the operating device application program.

An essential idea of the invention is that an identical intermediate code is used in the field device and in the operating device. In this way, the operating device has available the full functionality of the field device without the use of device description. The intermediate code can be produced from essentially any programming language. A limitation to a certain programming language is no longer required. In this way, that only a certain part of the field device application program, i.e. that which concerns the functionality of the field device, is produced by way of the intermediate code, the memory requirement and the compiler expense is kept to a minimum.

In a further development of the invention, Microsoft Intermediate Language is employed as the intermediate code.

Advantageously, the intermediate code with a corresponding compiler is produced from one of the programming languages C#, C/C++, Visual Basic, Java Script, etc.

In a further development of the invention, the intermediate code is suited for a realtime environment on the Microsoft®-Platform.

The operating device can advantageously be a PC, a control system, a handheld operating device, or a radio telephone (cell phone).

The invention will now be explained in greater detail on the basis of the drawings, which show as follows:

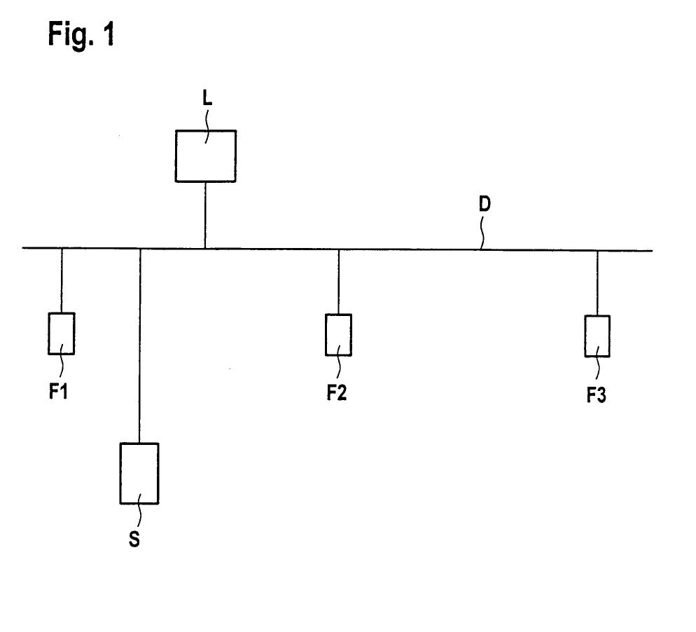

FIG. 1: Block diagram of an automation setup; and

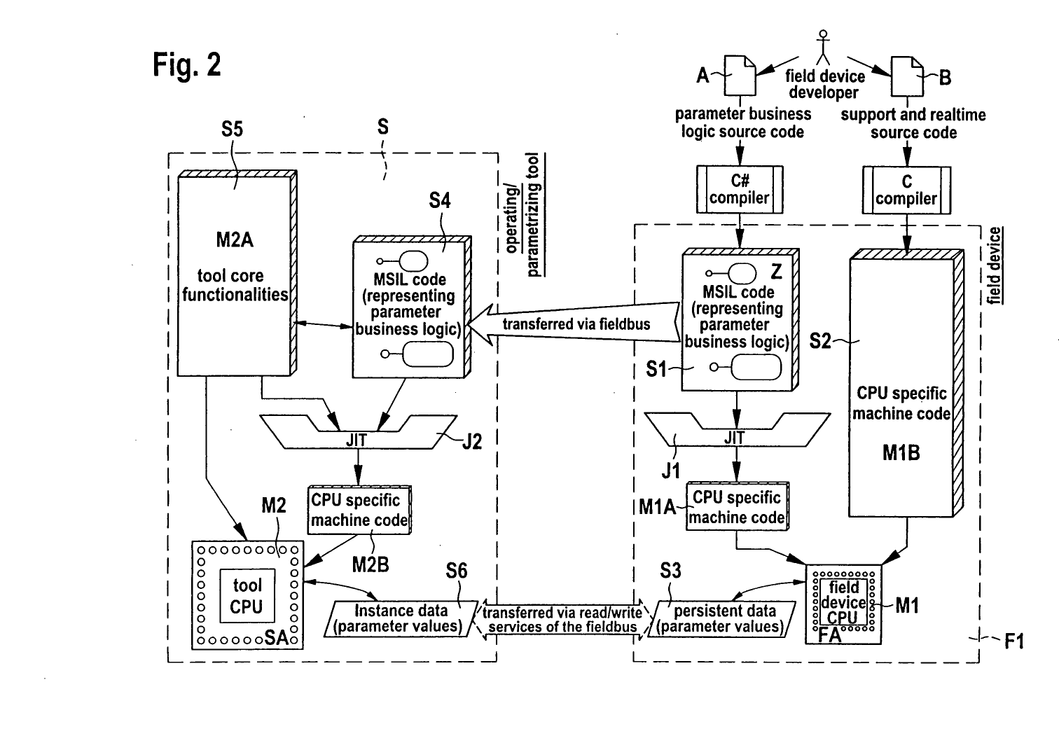

FIG. 2: Software relevant function blocks of a field device of FIG. 1.

A control system L is connected over a data bus D with a plurality of field devices F1, F2, F3, etc.. The field devices F1-F3 can be e.g. pressure measurers, temperature measurers, flow meters, etc. The control system L communicates over the data base D with the individual field devices, e.g. F1. In this way, data can be transmitted between the field device F1 and the control system. The data communication on the data bus D occurs on the basis of the appropriate international standards, such as e.g. Profibus, CAN or FF. The remote control and/or remote operation can occur from an operating device S over the data bus D. The operating device S can be: A portable computer, which is connected either directly to the field device or to the data bus; the control system L itself; handheld operating devices; or radio telephones that enable a data exchange with the field device.

The method of the invention will now be explained in greater detail on the basis of FIG. 2.

FIG. 2 shows only the software-relevant function blocks of the field device F1 and the operating device. All other function blocks, such as e.g. measurement sensor, on-site operation, data bus interface, etc. of the field device, and the corresponding function blocks of the operating device, such as e.g. operating elements or data bus interface, have been omitted for sake of clarity.

The field device application program, which, as a rule, is produced by a developer at the field device manufacturer, has essentially two parts, namely a Program Part A (parameter business logic source code) describing the functionality of the field device, and a Program Part B (support and realtime source code). Both program parts, A and B, can be written in one of the known programming languages, such as e.g. C#, C/C++, Visual Basic, Java Script, etc.

Program Part A is processed with a corresponding compiler (e.g. C# compiler) to produce an intermediate code Z, which is stored in a memory S1 in the field device F1.

Program Part B is processed with a corresponding compiler (e.g. C compiler) to produce a machine code M1B, which is stored in a memory S2 of the field device F1. The intermediate code Z is processed with the help of a corresponding interpreter J1 (e.g. Just in Time) to produce a machine code M1A. Both machine codes M1A and M1B are executed in the microprocessor M1 and form the field device application program FA. All persistent data, e.g. the parameters of the field device F1, are stored in an additional memory S3.

In order to enable remote operation and/or remote control of the field device F1 from an operating device S, the functionality of the field device F1 must be known to the operating device S. For this purpose, the intermediate code Z is transmitted to the operating device S and stored in a memory S4. The operating device S can be e.g. the control system L, a portable computer (laptop) or a handheld operating device or a radio telephone. The transmission of the intermediate code Z can correspondingly occur over the data bus D or over a direct connection on the field device or with radio waves. The tool core functionalities are stored in a memory S5 in a machine code M2A. The intermediate code Z is processed with the help of a corresponding interpreter J2 (e.g. Just in Time) to produce a machine code M2B. In the microprocessor M2, the two machine codes M2A and M2B form the operating device application program SA. The parameters of the field device F1 for the execution of the program SA are likewise transmitted to the operating device S and stored in a memory S6.

A remote operation and/or a remote control of the field device F1 can occur from the operating device S by execution of the operating device application program. The full functionality of the field device F1 is available to the operating device S.

It is conceivable that MSIL (Microsoft® Intermediate Language) be preferred for the intermediate code Z. Preferably, the intermediate code Z is suited for a Microsoft realtime environment.

1. A method for the remote operating and/or remote control of a field device F1 by means of an operating device S over a data bus D, comprising the steps of:
Storing in the field device F1 an intermediate code Z describing the functionality of the field device F1;
converting the intermediate code Z with an interpreter J1 into a field device machine code, which is part of a field device application program;
transmitting the intermediate code Z to the operating device S;
converting the intermediate code Z with an interpreter J2 into an operating device machine code, which is part of an operating device application program, so that the identical functionality of the field device F1 is available in the operating device;
transmitting the field device parameters to the operating device S; and
executing the operating device application program.

2. The method as claimed in claim 1, wherein the language MSIL (Microsoft Intermediate Language) is employed for the intermediate code.

3. The method as claimed in claim 1, wherein the intermediate code is produced by an appropriate compiler from one of the programming languages C#, C/C++, Visual Basic, Java Script.

4. The method as claimed in claim 1, wherein the intermediate code Z is suited for a realtime environment on the Microsoft Platform.

5. The method as claimed in claim 1, wherein the operating device S is a handheld operating device.

6. The method as claimed in claim 1, wherein the operating device S is a control system L.

7. The method as claimed in claim 1, wherein the operating device S is a portable computer (laptop).

8. The method as claimed in claim 2, wherein the intermediate code is produced by an appropriate compiler from one of the programming languages C#, C/C++, Visual Basic, Java Script.
